(19) United States
(12) Patent Application Publication
(10) Pub. No.: US 2017/0161194 A1
(43) Pub. Date: Jun. 8, 2017

(54) PAGE-BASED PREFETCHING TRIGGERED BY TLB ACTIVITY

(71) Applicant: Advanced Micro Devices, Inc., Sunnyvale, CA (US)

(72) Inventor: Gabriel Loh, Bellevue, WA (US)

(21) Appl. No.: 14/957,526

(22) Filed: Dec. 2, 2015

(51) Int. Cl. G06F 12/08; G06F 12/10

(52) U.S. Cl. CPC G06F 12/0862; G06F 12/1063; G06F 2212/1021; G06F 2212/507; G06F 2212/602; G06F 2212/684

(57) ABSTRACT

A method of prefetching data includes issuing to a translation lookaside buffer (TLB) an address translation request for a virtual memory address, detecting a TLB miss generated in response to the address translation request, and in response to the TLB miss, selecting the data for prefetching from memory based on the memory address causing the TLB miss and prefetching the selected data to a cache.

### TECHNICAL FIELD

This disclosure relates to the field of memory management and, in particular, to prefetching of data in a computing system.

### BACKGROUND

A processor in a modern computing system can typically operate much more quickly than a main memory that stores instructions or other data used by the processor. Thus, in many cases a smaller and faster cache memory is used in conjunction with the main memory to provide quick access to the instructions or data. Prefetching of data to the cache occurs when the processor requests data to be stored in the cache before the data is actually needed. Then, when the data is needed, it can be retrieved from the cache without incurring the additional latency of requesting it from the main memory.

Since most programs are executed sequentially or exhibit other regular patterns of execution, instructions or other data can be fetched in program order or according to other identified patterns in the memory access stream. However, prefetching incorrect data, or prefetching data at an inappropriate time can reduce the overall benefit provided by the prefetching implementation.

### BRIEF DESCRIPTION OF THE DRAWINGS

The present disclosure is illustrated by way of example, and not by way of limitation, in the figures of the accompanying drawings.

FIG. 1 illustrates an embodiment of compunting system.

FIG. 2 illustrates a functional block diagram of components in a computing system, according to an embodiment.

FIG. 3A illustrates a timeline for a prefetch sequence, according to an embodiment.

FIG. 3B illustrates a timeline for a prefetch sequence, according to an embodiment.

FIG. 4 is a flow diagram illustrating a process of prefetching data, according to an embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the spirit and scope of the embodiments.

In a computing system, an effective prefetcher should accurately identify the correct data to prefetch and should also prefetch the data in a timely manner. One embodiment of a prefetcher identifies the data to be prefetched and performs the prefetching at a particular time according to activities associated with a translation-lookaside buffer (TLB) and a hardware page table walker. When a memory access, such as a load or store operation, issues from a processor, a virtual address for a requested memory block is translated to a physical address that can then be used to complete that cache access. If a cache miss occurs, the physical address can be used to access the requested data in the main memory.

Address translation information for translating the virtual address to a physical address is stored in a page table and cached in a TLB. Thus, the processor first issues an address translation request to the TLB identifying the virtual address to be translated. When a request causes a TLB miss, a hardware page-table walker (PTW) is invoked to walk the page table (requiring several sequential accesses to memory) to retrieve the translation. Invoking the PTW causes the load or store instruction to stall, and can stall the entire processor pipeline.

One embodiment of a prefetcher mechanism uses the TLB miss event to trigger accurate and timely prefetches. A TLB miss for a given virtual address can indicate that the memory page corresponding to the virtual address likely has not been accessed for a long time, such that cachelines originating from that page are less likely to be in the cache. In addition, TLB miss information is available prior to cache miss information in embodiments where a processor does not issue the corresponding load or store request to the cache until after the TLB miss has been handled.

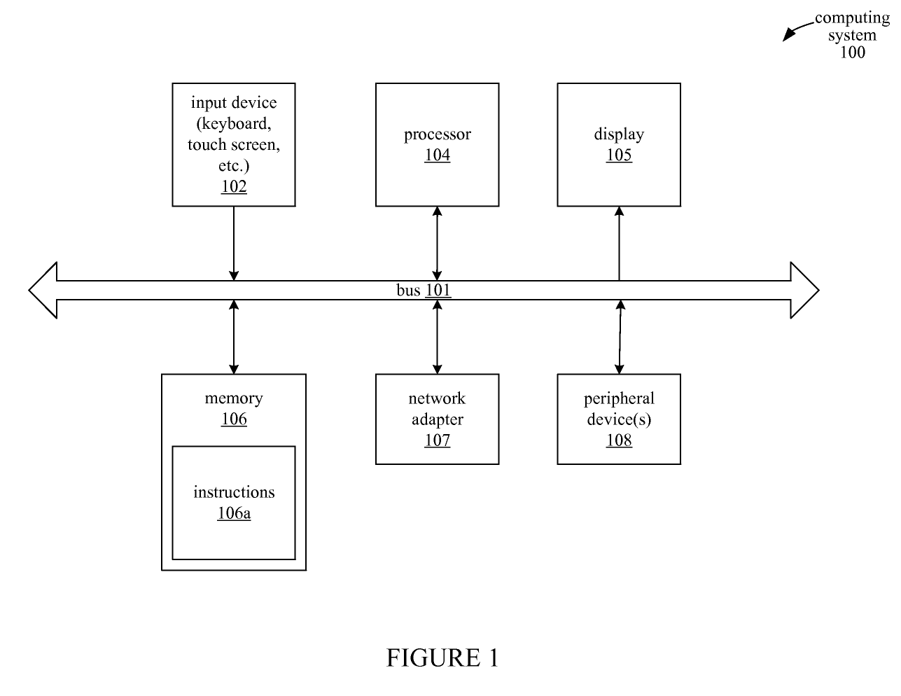

FIG. 1 illustrates an embodiment of a computing system 100 which may implement the prefetching mechanism as described above. In general, the computing system 100 may be embodied as any of a number of different types of devices, including but not limited to a laptop or desktop computer, mobile phone, server, etc. The computing system 100 includes a number of components 102-108 that can communicate with each other through a bus 101. In computing system 100, each of the components 102-108 is capable of communicating with any of the other components 102-108 either directly through the bus 101, or via one or more of the other components 102-108. The components 101-108 in computing system 100 are contained within a single physical casing, such as a laptop or desktop chassis, or a mobile phone casing. In alternative embodiments, some of the components of computing system 100 may be embodied as peripheral devices such that the entire computing system 100 does not reside within a single physical casing.

The computing system 100 also includes user interface devices for receiving information from or providing information to a user. Specifically, the computing system 100 includes an input device 102, such as a keyboard, mouse, touch-screen, or other device for receiving information from the user. The computing system 100 displays information to the user via a display 105, such as a monitor, light-emitting diode (LED) display, liquid crystal display, or other output device.

Computing system 100 additionally may include a network adapter 107 for transmitting and receiving data over a wired or wireless network. Computing system 100 also includes one or more peripheral devices 108. The peripheral devices 108 may include mass storage devices, location detection devices, sensors, input devices, or other types of devices that can be used by the computing system 100.

Computing system 100 includes a processor 104 that is configured to receive and execute instructions 106a that are stored in the main memory 106. As referenced herein, processor 104 represents a processor “pipeline”, and could include central processing unit (CPU) pipelines, graphics processing unit (GPU) pipelines, or other computing engines that support memory operations that use virtual addresses. Main memory 106 may be part of a memory subsystem of the computing system 100 that includes memory devices used by the computing system 100, such as random-access memory (RAM) modules, read-only memory (ROM) modules, hard disks, and other non-transitory computer-readable media.

In addition to the main memory 106, the memory subsystem may also include cache memories, such as L2 or L3 caches, and/or registers. Such cache memory and registers may be present in the processor 104 or on other components of the computing system 100.

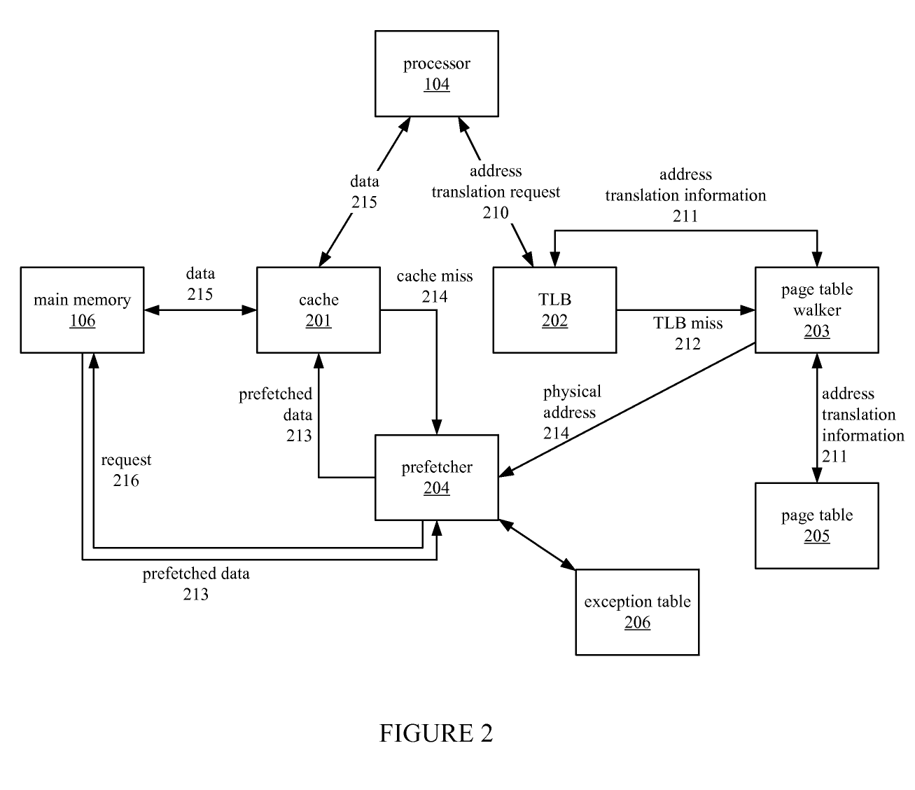

FIG. 2 is a functional block diagram that illustrates relationships between different components of computing system 100, according to an embodiment. In FIG. 2, various communication pathways are illustrated between the components 104, 106, 201, 202, 203, 204, and 205; however, additional pathways may exist between the components other than those that are illustrated. For example, the processor 104 may also have direct access to the main memory 106.

Main memory 106 stores data 215, including instructions 106a that can be executed by the processor 104. The instructions 106a may also direct the processor to perform various operations on other data 215 that is stored in the memory 106. Data 215 from the main memory 106 is cached in the cache 201, which is smaller in capacity and faster (i.e., having lower latency) than the main memory 106, to allow quicker access to the cached data 215 by the processor 104. The cache 201 may include multiple levels, such as level 1 (L1), level 2 (L2), and level 3 (L3) caches. Each cache line in the cache 201 stores data copied from a memory block in main memory 106.

In the event that the processor 104 requests data that is not stored in cache 201, the cache 201 generates a cache miss 214. In one embodiment, the prefetcher 204 detects the cache miss 214, which triggers the prefetcher 204 to prefetch data 213 from the main memory 106 to the cache 201. For example, the prefetcher 204 may transmit a request 216 to the main memory 106 to request the prefetched data 213. In response to the cache miss 214, the prefetcher 204 may determine the data to be prefetched based on prior patterns of memory accesses, branch predictions, etc.

The computer system 100 utilizes virtual memory addressing; therefore, in order to access the cache 201 and main memory 106, the processor 104 requests translation of a virtual memory address to a physical memory address. A memory access request (e.g., load or store) for data in the main memory 106 that is issued by the processor specifies the virtual address corresponding to the requested data. The virtual address is translated to a physical memory address that identifies the actual location of the requested data block in main memory 106. The address translation information 211 that allows the translation of virtual memory addresses to physical memory addresses is stored in the page table 205, which resides in main memory 106. The address translation information 211 in page table 205 includes multiple address translations each specifying a virtual base address for a memory page. Each address translation in the page table 205 also correlates the virtual base address for the memory page with a physical base memory address for a memory page, which represents a portion (e.g., 4 kilobytes) of main memory 106.

A portion of the address translation information 211 is cached in the TLB 202, which is smaller in capacity and faster (i.e., lower latency) than the main memory 106 storing the page table 205. The TLB 202 thus provides quick access to the address translation information 211 when the processor 104 requests the translation of a virtual address to a physical address in conjunction with a load or store memory access request. When issuing a memory access request, the processor 104 attempts to perform address translation 210 via the TLB 202, issuing an address translation request 210 to the TLB 202 for a particular virtual memory address.

If the address translation information for the requested virtual memory address is not located in the TLB 202, the TLB 202 will fail to locate the entry and will generate a TLB miss 212 in response to the address translation request 210. In response to the TLB miss 212, the page table walker 203 traverses the page table 205 to locate the correct address translation for the requested virtual address. The located address translation is then cached in the TLB 202 for future use.

In one embodiment, the requested virtual memory address in the address translation request 210 is interpreted as a virtual base memory address plus an offset, and the page table walker 203 traverses the page table 205 to determine a physical base memory address corresponding to the requested virtual base memory address. The returned physical base address identifies a physical memory page in the main memory 106; thus, when the page table walker 203 identifies the physical page corresponding to the requested virtual address, the page table walker 203 sends the physical page address 214 to the prefetcher 204 and causes the prefetcher 204 to prefetch the page. The prefetcher 204 receives the physical address 214 of the page and selects the identified page as the portion of memory to prefetch. The prefetcher 204 then retrieves prefetched data 213 from the page in main memory 106 to the cache 201. In alternative embodiments, the prefetcher 204 can prefetch data from other parts of the memory subsystem, such as cache memory, instead of prefetching the data from main memory 106. For example, cache 201 may be an L2 cache, and the prefetcher 204 may prefetch data from an L3 cache to the L2 cache 201. While the prefetcher 204 is illustrated in FIG. 2 as a separate component, the prefetcher 204 in alternative embodiments may be implemented as logic in one of the other components such as page table walker 203, for example.

In one embodiment, the prefetcher 204 begins from the lowest address (i.e., corresponding to the first cacheline) of the page and prefetches data blocks from each address of the page sequentially in ascending order until the end (i.e., the highest address) of the page is reached. The prefetcher 204 may optionally reduce the amount of data that is prefetched by predicting which subset of blocks in the memory page are most likely to be accessed and therefore should be prefetched. The prediction may be based on a prior pattern of memory accesses, past instructions, branch predictions, etc. In one embodiment, the prefetcher 204 selects data from the main memory 106 for prefetching based on the virtual memory address of the address translation request 210 causing the TLB miss; for example, the prefetcher 204 may select a subset of the closest data blocks before and/or after the block identified by the requested virtual memory address to prefetch.

The computing system 100 also includes an exception table 206 coupled with the prefetcher 204 that stores a list of memory portions to be excepted from the normal prefetch routine. In one embodiment, the exception table 206 is used to implement a blacklist that keeps track of memory pages for which page-wide prefetching should not be performed. For instance, the exception table 206 can be configured to list pages for which fewer than a threshold number of the cache lines from the page had been used in the past within a given time period after a first access of the page. Based on the access history of these blacklisted memory pages, a TLB miss does not necessarily indicate likely imminent accesses to other cache lines for blocks in the same page.

As such, a prefetcher 204 that prefetches in response to a TLB miss 212 additionally checks the exception table 206 to determine whether or not the data selected for prefetching is included or excluded from the excepted portions of memory (e.g., memory pages) that are listed in the exception table 206. If the data selected for prefetching (e.g., the memory page of the requested address) is listed in the exception table 206, the prefetcher 204 does not prefetch the data. If the data selected for prefetching is excluded from the exception table 206, the prefetcher 204 continues to prefetch the selected data.

In embodiments where the prefetcher 204 prefetches the data block for the requested address prior to other blocks in the same page, checking of the exception table 206 need not delay prefetching of the data block for the requested address. The prefetcher 204 may check the exception table 206 in parallel with or after issuing the prefetch for the requested address. If the exception table 206 indicates that the rest of the page should not be prefetched, then the prefetcher 204 stops. Otherwise, the prefetcher 204 continues prefetching the remainder of the page.

The prefetcher 204 may alternatively be configured to, by default, prefetch only the data block at the specifically requested address and not prefetch the rest of the page. Accordingly, the exception table can function as a whitelist table that records pages that should be prefetched, such as pages for which more than a threshold number of the page's cache lines were accessed within a given time after one cache line in the page was accessed. Based on the access history of these whitelisted memory pages, an access to the memory page corresponds to likely imminent accesses to other blocks in the same page. Upon checking the whitelist exception table 206, the prefetcher 204 continues with the prefetch operation if the page containing the requested block is included in the exception table 206. If the page is excluded from the exception table 206, the prefetcher 204 cancels the prefetch operation, or may only prefetch the block that was specifically requested by the original memory access.

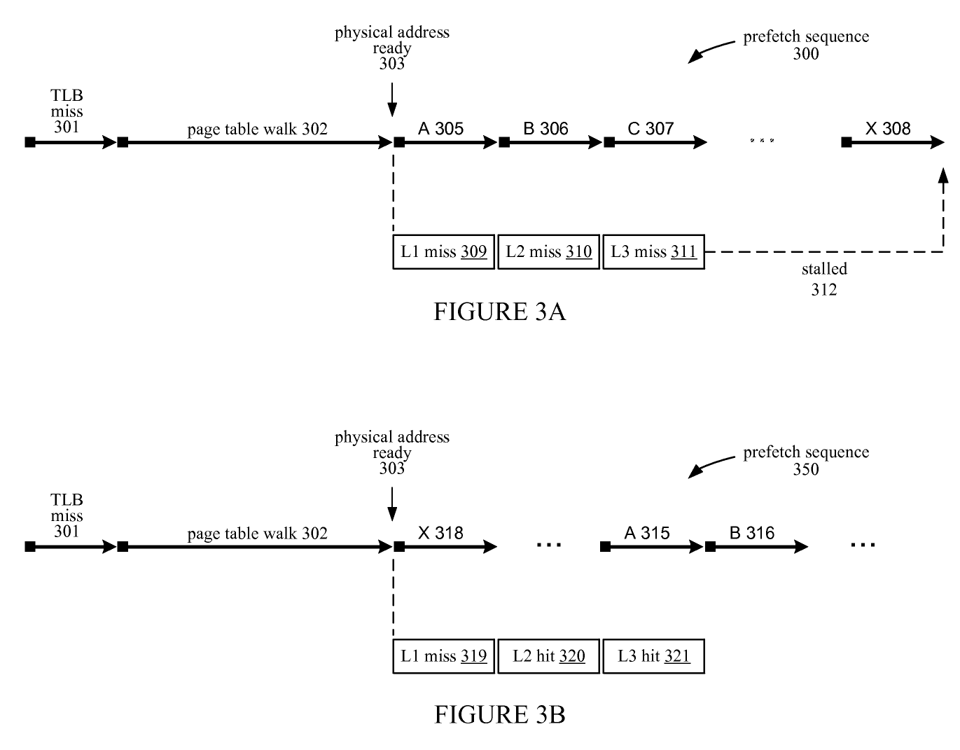

FIGS. 3A and 3B are timelines illustrating prefetch sequences 300 and 350 that can be performed by the prefetcher 204, according to an embodiment. In FIGS. 3A and 3B, time advances from left to right. FIG. 3A illustrates a timeline for a prefetch sequence 300 that is triggered by a TLB miss 212 that occurs at time 301. The TLB miss 212 results from an address translation request for a virtual memory address with offset X. In response to the TLB miss at time 301, the page table walker 203 performs a page table walk of (i.e., traverses the address translations in) page table 205 at time 302. At time 303, the physical address corresponding to the requested virtual address is available as a result of the page table walk. The physical address is a physical base address that identifies a memory page in the main memory 106.

In prefetch sequence 300, the prefetcher 204 prefetches blocks A, B, C, etc. of the identified memory page in sequence, starting from the first block at offset A in the memory page. Thus, the prefetcher 204 prefetches block A at time 305, block B at time 306, block C at time 307, and the requested block X at time 308.

At time 303, the physical address is ready and the load or store operation can also resume in parallel with the prefetching operation. Thus, the processor 104 uses the physical address to perform cache lookups in cache 201 for the requested block X while the prefetcher 204 prefetches blocks A, B, C, etc. from the memory page. The processor 104 attempts to lookup the block X data starting from the level 1 (L1) cache at time 309, then proceeding to the level 2 (L2) and level 3 (L3) caches at times 310 and 311, respectively. In the case where block X is not already present in the cache 201, each of the L1, L2, and L3 cache lookups will result in a miss. Since the requested data block X is not prefetched to the cache 201 until the end of time 308, the processor 104 will be stalled for time 312 until block X is prefetched. The stalled period 312 may be particularly long in situations where block X is located toward the end of the memory page.

Prefetch sequence 350 is similarly initiated by a TLB miss at time 301, followed by a page table walk at time 302 which returns a physical base address at time 303. In prefetch sequence 350, the prefetcher 204 also receives the offset X of the requested block, and can calculate the physical address of the requested block by adding the offset X to the physical base address. The prefetcher 204 can then prefetch data from the identified memory page sequentially from successive memory addresses of the page in ascending order (i.e., identifying consecutive blocks), starting from the requested block at offset X, instead of starting from block A at the beginning of the page. After prefetching block X at time 318, the prefetcher 204 continues prefetching data from subsequent consecutive blocks in order until reaching the end of the page. The prefetcher 204 then returns to the beginning of the page to prefetch block A at time 315, block B at time 316, etc. sequentially and in ascending order until the entire page has been prefetched.

In prefetch sequence 350, since the requested block X is the first block in the page to be prefetched, the data is more likely to have been prefetched to the cache by the time at least one of the cache lookups L1 at time 319, L2 at time 320, and L3 at time 321 are performed. As illustrated in FIG. 3B, the prefetch of block X is completed by the time the L2 and L3 cache lookups occur; accordingly, the lookup for the L2 or L3 cache in which the prefetched data is installed results in a cache hit.

The prefetcher 204 is also capable of responding to a TLB miss by performing a prefetch sequence that prefetches blocks based on observing a pattern of memory accesses. For example, in a system utilizing 64-byte blocks, if a first memory access request is directed to address ‘5248’, and subsequent request is directed to address ‘5120’, a prefetch sequence similar to sequence 350 would start at address ‘5248’, and then prefetch the rest of the page (i.e., ‘5312’, ‘5376’, ‘5440’, etc., up to ‘8128’), before wrapping around to addresses ‘4096’, ‘4160’, and eventually reaching the address specified in the second request ‘5120’. In this situation, data for the first request would be timely prefetched to the L3 cache; however, the second request would be stalled while other blocks in the page are being prefetched.

Such delay can be mitigated by configuring the prefetcher 204 to perform a prefetch sequence that accounts for memory access patterns; for example, the prefetcher 204 can compare the offsets of sequential memory accesses and determine whether the requested addresses are in ascending or descending order. Referring back to the previous example, the prefetcher 204 accounting for memory access patterns would observe both of the requests to addresses 5248 and 5120, determine that these are in a descending order, and then prefetch the page sequentially in descending order starting from 5248 (i.e., 5248, 5184, 5120, 5056, etc.). Alternatively, the prefetcher 204 may be configured to issue prefetches for two or more requested addresses (e.g., 5248 and 5120) prior to a sequential prefetch of the rest of the page. In the previous example, this results in addresses 5248, 5120, 4096, 4160, etc. being prefetched in respective order.

In one embodiment, the prefetcher 204 is reconfigurable to implement any of the above-described prefetching sequences. The prefetcher 204 may additionally be configured to adhere to other restrictions; for example, the prefetcher 204 may limit cache pollution of smaller higher-level caches (e.g., L1, L2) by prefetching pages only into a lower-level cache (e.g., L3).

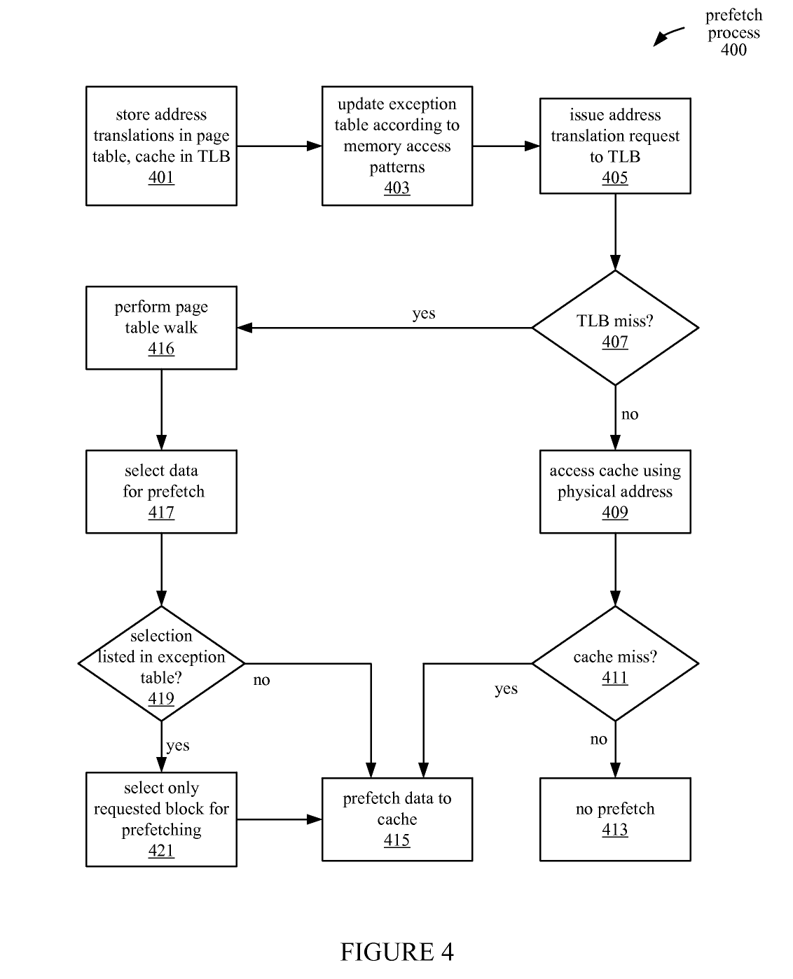

FIG. 4 is a flow diagram illustrating a process 400 for prefetching data from a main memory to a cache in response to a TLB miss. In one embodiment, the process 400 is performed by components in the computing system 100, including the processor 104 and prefetcher 204.

The process 400 begins at block 401. The computing system 100 implements virtual addressing; thus, at block 401, a page table 205 is used to store address translation information for translating virtual addresses to physical addresses. Each of the address translation entries correlates a virtual memory address with a physical address which is also a physical base address of a memory page in main memory 106. The address translation entries can thus be used to translate a virtual memory address (represented as a base address plus an offset) by translating the virtual base address to the corresponding physical base address, then adding the offset to the physical base address.

To speed up the address translation process, the address translation entries are cached in the TLB 202, which is implemented using a smaller and faster memory than the memory in which the page table resides. The TLB 202 stores a portion of the address translation information that is included in the page table 205. From block 401, the process 400 continues at block 403.

At block 403, the computing system 100 updates the exception table 206 based on observing memory access patterns. For example, when the exception table 206 is configured as a blacklist, the exception table 206 can be used to record pages for which a memory access to an address within the page was not followed by additional memory accesses in the same page. One or more thresholds may be used to determine whether a page is recorded in the exception table; for example, the page may be recorded if, after a first access to an address in the page, fewer than a threshold number of accesses to the same page occurred within a threshold time duration after the first access. When the exception table is configured as a whitelist, the page may be recorded if a memory access to an address within the page was followed by more than a threshold number of accesses to other addresses in the same page within a threshold time duration after the first access. From block 403, the process 400 continues at block 405.

At block 405, the processor 104 issues an address translation request 210 to the TLB 202. The address translation request 210 is issued pursuant to a memory access request (e.g., a load or store operation) for data stored in the main memory 106. The address translation request 210 specifies a virtual memory address to be translated to its corresponding physical address identifying the actual location of data in the main memory 106. From block 405, the process 400 continues at block 407.

At block 407, the TLB receives the address translation request 210. If the address translation for the requested virtual address is cached in the TLB 202, the TLB can use the translation to provide the physical address corresponding to the requested virtual address. In this case, a TLB miss 212 is not generated, and the process 400 continues at block 409.

At block 409, the process 104 continues the memory access request by requesting data from the cache 201 using the physical memory address returned by the TLB 202 lookup. If the requested data is present in the cache 201, the cache 201 returns the data and a cache hit occurs instead of a cache miss at block 411. The process 400 thus proceeds to block 413, where no prefetch occurs, since the data is already present in the cache.

If the data is not present in the cache 201, then a cache miss 214 occurs at block 411, and the process 400 continues at block 415. The prefetcher 204 detects the cache miss 214 and prefetches data 213 from the main memory 106 to the cache 201. In one embodiment, the prefetching may be performed in response to other types of cache events or activity in addition to or instead of the cache miss event 214.

At block 407, if an address translation entry for the requested virtual address is not present in the TLB 202, the TLB fails to locate the address translation entry and instead generates a TLB miss 212 in response to the address translation request 210. In response to the TLB miss 212, the process 400 continues at block 416. At block 416, the page table walker 203 traverses the page table 205 to determine the physical address corresponding to the requested virtual address. The prefetcher 204 detects the TLB miss 212 by receiving the physical memory address 214 from the page table walker 203, and thus begins a prefetching sequence in response to the TLB miss 212. From block 416, the process 400 continues at block 417.

At block 417, the prefetcher 204 selects data for prefetching based on the virtual memory address causing the TLB miss; specifically, the data is selected based on the physical address 214 corresponding to the virtual base address. In one configuration, the prefetcher 204 may identify a memory page indicated by the original address translation request 210 and select all or a portion of the data in the memory page for prefetching. For example, the physical base address corresponding to the requested virtual base address may indicate the start address of the memory page to be selected for prefetching. In other configurations, the prefetcher 204 may select a number of blocks before and/or after the block identified by the physical address 214, or may select blocks for prefetching based on a previously identified memory access pattern, instruction branch prediction, etc. From block 417, the process 400 continues at block 419.

At block 419, the prefetcher 204 checks the exception table 206 to determine whether the data initially selected for prefetching is listed in the exception table 206. FIG. 4 illustrates the process 400 when the exception table 206 is configured as a blacklist that lists memory regions for which additional prefetching should not occur. Thus, if the data initially selected for prefetching is in a memory region that is listed in the exception table 206, the process 400 proceeds to block 421. For example, the exception table 206 may list the selected memory region if the computing system 100 had previously identified a pattern of memory accesses correlated to the requested virtual or physical memory addresses. At block 421, the prefetcher 204 adjusts the selection to include only the block explicitly requested in the original memory access request for prefetching, then prefetches the selected data 213 from the main memory 106 to the cache 201 at block 415. At block 419, if the data initially selected for prefetching is excluded from the memory regions listed in exception table 419, then the prefetcher 204 prefetches the selected data at block 415.

In an alternative configuration where the exception table 206 is configured as a whitelist, the prefetcher 204 selects only the requested block by default (as provided at block 421) for prefetching and selects the rest of the page (or portions of the page) in which the block is located for prefetching if the page is listed in the exception table 206.

At block 415, the prefetcher 204 prefetches the selected data from the main memory 106 to the cache 201. If the data selected for prefetching includes more than the requested block as specified in the original request, the prefetching may proceed according to one of the sequences as previously described. For example, the entire memory page or a selected portion of the memory page may be prefetched starting from the physical memory address corresponding to the originally requested virtual memory address and proceeding sequentially through successive memory addresses in ascending order.

According to the operation of the prefetching process 400, the computing system 100 thus performs timely and accurate prefetches that are triggered by TLB 202 and page table walker 203 activity (e.g., a TLB miss) in addition to cache activity (e.g., a cache miss).

As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the prefetcher 204 and/or portions thereof carried on the computer-readable storage medium may be a database or other data structure which can be read by a program and used, directly or indirectly, to fabricate the hardware comprising the prefetcher 204. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the prefetcher 204. The netlist may then be placed and routed to produce a data set describing geometric shapes to be applied to masks. The masks may then be used in various semiconductor fabrication steps to produce a semiconductor circuit or circuits corresponding to the the prefetcher 204. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the scope of the embodiments as set forth in the appended claims. The specification and drawings are, accordingly, to be regarded in an illustrative sense rather than a restrictive sense.

What is claimed is:

1. A method, comprising:
issuing an address translation request for a virtual memory address to a translation lookaside buffer (TLB);
in response to a TLB miss generated in response to the address translation request, selecting data for prefetching from a memory subsystem based on the virtual memory address causing the TLB miss; and
prefetching the selected data from the memory subsystem to a cache.

2. The method of claim 1, further comprising:
in response to detecting a cache miss resulting from a memory request at the cache, performing an additional prefetch of additional data from the memory subsystem to the cache.

3. The method of claim 1, further comprising:
storing address translation information in a page table, wherein the address translation information includes an entry identifying a physical memory address corresponding to the virtual memory address; and
caching a portion of the address translation information in the TLB; and
generating the TLB miss based on failing to locate the entry for the virtual memory address in the TLB in response to the address translation request.

4. The method of claim 1, wherein the prefetching further comprises:
sequentially prefetching the selected data from successive memory addresses in a memory page, beginning from a physical memory address corresponding to the virtual memory address.

5. The method of claim 4, wherein the sequential prefetching of the selected data from successive memory addresses is performed in an ascending order of memory addresses.

6. The method of claim 1, wherein selecting the data for prefetching further comprises:
identifying a memory page indicated by the address translation request; and
selecting data in the identified memory page as the selected data for prefetching.

7. The method of claim 1, further comprising:
storing a list identifying a plurality of memory portions in an exception table.

8. The method of claim 7, wherein the prefetching to the cache is performed in response to determining that the data selected for prefetching is excluded from the memory portions listed in the exception table.

9. The method of claim 1, further comprising:
prior to issuing the address translation request, identifying a pattern of memory accesses including the virtual memory address, wherein the data for prefetching is selected based on the identified pattern.

10. An apparatus, comprising:
a processor configured to issue an address translation request for a virtual memory address to a translation lookaside buffer (TLB);
a prefetcher coupled with the processor and a memory subsystem and configured to, in response to detecting a TLB miss generated by the TLB in response to the address translation request:
select data from the memory subsystem for prefetching based on the virtual memory address causing the TLB miss; and
prefetch the selected data the selected data from the memory subsystem to a cache.

11. The apparatus of claim 10, wherein the prefetcher is further configured to:
in response to detecting a cache miss resulting from a memory request at the cache perform a second prefetch of memory to the cache.

12. The apparatus of claim 10, wherein the prefetcher is further configured to sequentially prefetch the selected data from successive memory addresses of the selected data from the memory subsystem, beginning from a physical memory address corresponding to the virtual memory address.

13. The apparatus of claim 12, wherein the prefetcher is further configured to prefetch the selected data from successive memory addresses according to an ascending order of memory addresses.

14. The apparatus of claim 10, wherein the prefetcher is further configured to select the data for prefetching by identifying a memory page indicated by the address translation request and selecting data in the identified memory page as the selected data for prefetching.

15. The apparatus of claim 10, further comprising an exception table coupled with the prefetcher and configured to store a list identifying a plurality of memory portions, wherein the prefetcher is configured to perform the prefetching to the cache in response to determining that the data selected for prefetching is excluded from the memory portions listed in the exception table.

16. A computer system, comprising:
a memory subsystem including a main memory;
a translation lookaside buffer (TLB) configured to generate a TLB miss in response to an address translation request for a virtual memory address;
a processor coupled with the memory subsystem and the TLB and configured to issue the address translation request to the TLB;
a prefetcher coupled with the memory subsystem and the TLB and configured to, in response to the TLB miss:
select data from the memory subsystem for prefetching based on the virtual memory address causing the TLB miss; and
prefetch the selected data from the memory subsystem to a cache.

17. The computer system of claim 16, further comprising:
a page table configured to store address translation information, wherein the address translation information includes an entry identifying a physical memory address in the main memory corresponding to the virtual memory address, and wherein the TLB is further configured to:
cache a portion of the address translation information, and
generate the TLB miss in response to failing to locate the entry for the virtual memory address in the TLB in response to the address translation request.

18. The computer system of claim 16, wherein the prefetcher is further configured to select the data for prefetching by:
identifying a memory page indicated by the address translation request; and
selecting data in the identified memory page as the selected data for prefetching, wherein the prefetching further comprises sequentially prefetching data from successive memory addresses of the memory page in ascending order, beginning from a physical memory address corresponding to the virtual memory address.

19. The computer system of claim 16, wherein the prefetcher is further configured to select the data for prefetching by identifying a memory page indicated by the address translation request and selecting data in the identified memory page as the selected data for prefetching.

20. The computer system of claim 16, further comprising an exception table coupled with the prefetcher and configured to store a list identifying a plurality of memory portions, wherein the prefetcher is configured to perform the prefetching to the cache in response to determining that the data selected for prefetching is excluded from the memory portions listed in the exception table.
